(19) United States
(12) Patent Application Publication
(10) Pub. No.: US 2015/0282505 A1
(43) Pub. Date: Oct. 8, 2015

(54) Sweet potato equine feed

(71) Applicant: Stuart Ziglin, Wentzville, MO (US)

(72) Inventor: Stuart Ziglin, Wentzville, MO (US)

(21) Appl. No.: 13/999,949

(22) Filed: Apr. 8, 2014

(51) Int. Cl. A23K 1/18; A23K 1/14

(52) U.S. Cl. CPC A23K 1/1806; A23K 1/143

(57) ABSTRACT

The present invention is the use of sweet potatoes, skin or pulp, dehydrated or hydrated, as a feed or feed supplement for horses.

### BACKGROUND OF THE INVENTION

Horses or equine are domesticated animals with special and delicate feed requirements. Hog feed or cattle feed may not be appropriate or healthy for horses.

Sweet Potatoes have been fed to other domesticated animals such as hogs and cows but the inventor is not aware of sweet potatoes having previously been fed to horses.

The inventor began his research by experimenting on his own horses. The inventor fed his horses raw, chopped sweet potatoes. The chopped sweet potatoes consisted of the entire sweet potato: skin and pulp. The inventor's horses loved the sweet potatoes and thrived.

The inventor then experimented with feeding his horses just the skin or peelings from sweet potatoes which consisted of the skin with some pulp attached. Once again, his horses loved the sweet potato skins and thrived.

Because sweet potatoes are naturally moist and could deteriorate, be attacked by fungus, or spoil if the naturally moist sweet potato or chopped sweet potato were stored or transported, the inventor then experimented with dehydrated sweet potatoes. First, the inventor had sweet potato peelings (skin with some pulp) dehydrated or dried. The dehydrated sweet potato peelings could be stored or transported for days or weeks without spoiling.

The dehydrated sweet potatoes cannot be directly fed to horses. The dried sweet potatoes shrink and if the dehydrated sweet potatoes were directly fed to horses the horses would sicken and could die. In their gut and intestines, the dehydrated sweet potatoes would absorb water and fluid and expand. The horse would dehydrate and lose fluid to the formerly dehydrated sweet potatoes. The now hydrated and expanded sweet potatoes could injure, sicken, or kill the horse by injuring or blocking the horses gut or intestines.

The inventor experimented and determined that the proper method of rehydrating the dehydrated sweet potatoes was to place the dehydrated sweet potatoes in a waterproof container such as a bucket, fill the container with water, and allow the dehydrated sweet potatoes soak for a couple hours to completely rehydrate the sweet potatoes. After complete rehydration, the sweet potatoes can be safely fed to horses.

The advantages of this invention is that it provides that sweet potatoes, sliced or chopped sweet potatoes, or the peelings from sweet potatoes can be safely and effectively fed to horses. Sweet potatoes may also be powdered and added as a component to other equine feeds.

This invention provides for a use for the waste (peelings) from sweet potatoes. In addition, the dehydrated sweet potatoes may be transported and stored for lengthy periods of time for later feeding to horses.

### SUMMARY OF THE INVENTION

The invention as claimed has several embodiments but includes horse or equine feed which contains sweet potatoes, sliced sweet potatoes, or sweet potato peelings. The sweet potato equine feed may be naturally hydrated or may be dehydrated for transport or storage.

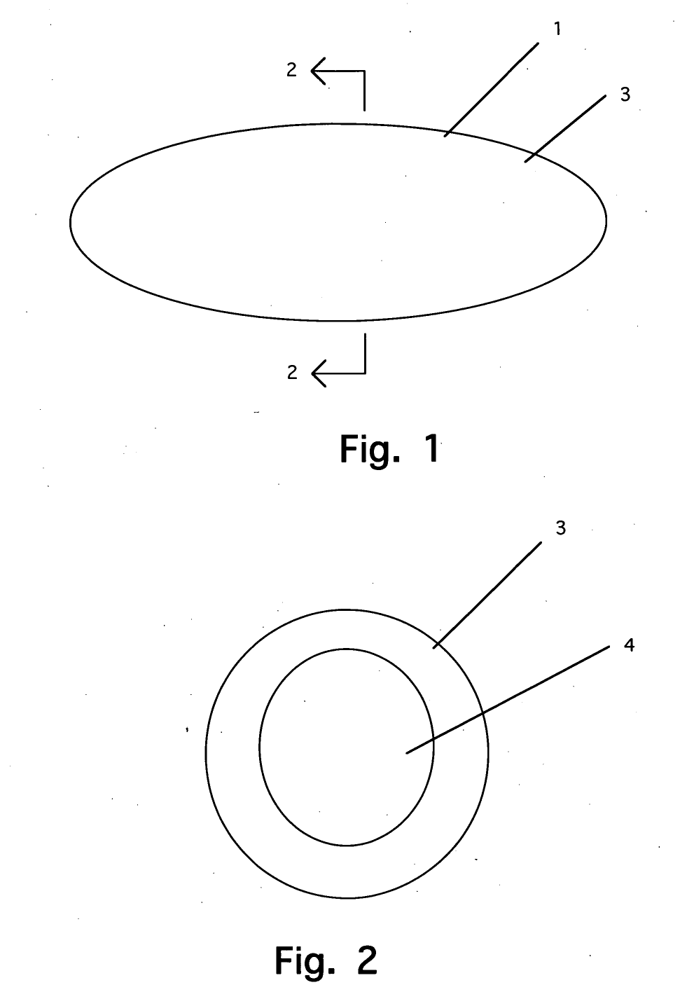

FIG. 1 is a drawing of a sweet potato showing the exterior of the sweet potato and the sweet potato's exterior skin.

FIG. 2 is a drawing of a cross section of a sweet potato showing the sweet potato skin and interior pulp.

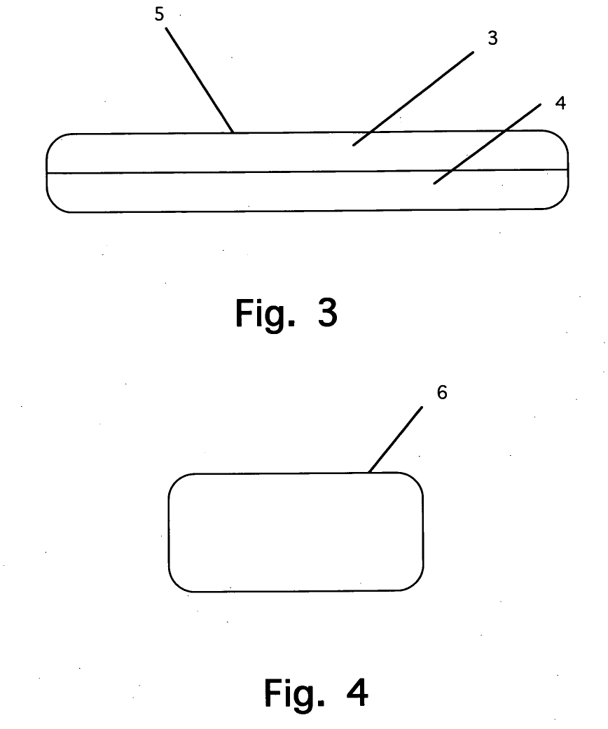

FIG. 3 is a drawing of a sweet potato peel showing the skin and pulp of the sweet potato.

FIG. 4 is a drawing of a slice of sweet potato.

### REFERENCE NUMERALS

1 Sweet Potato
3 Sweet Potato Skin
4 Sweet Potato Pulp
5 Sweet Potato Peel
6 Sweet Potato Slice

### DETAILED DESCRIPTION OF THE INVENTION

The invention has many embodiments not all of which can be listed or described here but are described in the claims.

The first embodiment of the invention is a horse or equine food containing sweet potatoes. The sweet potatoes are cut up or chopped up into slices or chunks so that they are easy for the horse to eat. The slices may consist of pulp alone, skin alone, or a combination of pulp or skin. The sweet potatoes may be a complete meal for the horse or just a component in their overall feed. The cut up sweet potatoes are sliced by knife or machine and later placed in the feed trough for the horse. The horse eats the sweet potato pieces directly from the trough.

The second embodiment of the invention is a horse or equine food consisting of sweet potato peelings. The peelings are waste from processed sweet potatoes. The peelings contain the skin and some of the pulp of the sweet potato. The peelings may be a complete meal for the horse or only a component of the overall feed. The peelings are peeled by knife or machine and placed in the feed trough for the horse. The horse eats the sweet potato peelings directly from the trough.

The third embodiment of the invention is a horse or equine feed which consists of dehydrated sweet potato peelings. The skin from the sweet potato is peeled with a knife or machine. The peelings include sweet potato skin and some of the pulp. The peelings are dehydrated or dried out. The peelings are then transported or stored. When it is time to feed the horse the dehydrated peelings the peelings are put in a bucket and the bucket is filled with water. The peelings are allowed to sit in a bucket, covered by water, for several hours. The sweet potato peelings are thereby rehydrated. The rehydrated or wet peelings are put in a trough for the horse to eat.

### CONCLUSION

Thus the reader will see that at least one embodiment of the Sweet Potato Equine Feed invention, is to provide a valuable use for sweet potatoes and the waste from processed sweet potatoes by using the sweet potatoes or their process waste as horse feed. The inventor is unaware of anyone previously feeding horses sweet potatoes.

While my above description contains much specificity, these should not be construed as limitations on the scope but as examples of one or more embodiments of the invention. Many other variations or embodiments of the invention are possible. For example the sweet potatoes can be the complete horse feed or only a component thereof. The sweet potatoes may be fed whole or cut up, peeled, or sliced. The sweet potato horse feed may be dehydrated. Accordingly the scope of the invention should be determined by the claims and their legal equivalents.

1. Equine feed which contains sweet potatoes.

2. The equine feed as claimed in claim 1, in which the sweet potato component of the equine feed consists of chopped up sweet potatoes.

3. The equine feed as claimed in claim 2, in which the sweet potato component of the equine feed is cooked.

4. The equine feed as claimed in claim 1, in which the sweet potato component of the equine feed consists of sweet potato peelings.

5. The equine feed as claimed in claim 4, in which the sweet potato component of the equine feed is cooked.

6. The equine feed as claimed in claim 1, in which the sweet potato component of the equine feed consists of sweet potato pulp.

7. The equine feed as claimed in claim 6, in which the sweet potato pulp has been cooked.

8. The equine feed as claimed in claim 1, in which the sweet potato component of the equine feed is dehydrated.

9. The equine feed as claimed in claim 2, in which the sweet potato component of the equine feed is dehydrated.

10. The equine feed as claimed in claim 3, in which the sweet potato component of the equine feed is dehydrated.

11. The equine feed as claimed in claim 4, in which the sweet potato component of the equine feed is dehydrated.

12. The equine feed as claimed in claim 6, in which the sweet potato component of the equine feed is dehydrated.

13. Additive for equine feed comprising sweet potatoes.

14. The additive for equine feed according to claim 13, wherein the sweet potatoes are sliced.

15. The additive for equine feed according to claim 13, wherein the sweet potatoes are sweet potato peels.

16. The additive for equine feed according to claim 13, wherein the sweet potatoes are dehydrated.
